(19) United States
(12) Patent Application Publication
(10) Pub. No.: US 2024/0007595 A1
(43) Pub. Date: Jan. 4, 2024

(54) CAMERA MONITORING SYSTEM, CONTROL METHOD FOR CAMERA MONITORING SYSTEM, AND STORAGE MEDIUM

(71) Applicant: CANON KABUSHIKI KAISHA, Tokyo (JP)

(72) Inventor: YUICHI SUEYOSHI, Tokyo (JP)

(21) Appl. No.: 18/343,519

(22) Filed: Jun. 28, 2023

(30) Foreign Application Priority Data
Jun. 30, 2022 (JP) 2022-106165

(51) Int. Cl. H04N 7/18; G06T 5/00; H04N 5/262; H04N 7/01

(52) U.S. Cl. CPC H04N 7/183; G06T 5/006; H04N 5/2628; H04N 7/0127; G06T 2207/30252; B60R 1/12

(57) ABSTRACT

A camera monitoring system includes an imaging unit arranged in a moving object, and having a low-resolution area corresponding to an angle of view that is smaller than a predetermined angle of view and a high-resolution area corresponding to an angle of view that is larger than or equal to the predetermined angle of view and having a resolution higher than a resolution of the low-resolution area, a generating unit configured to generate a first video image including the high-resolution area based on a captured video image and a second video image including a video image captured with the low-resolution area, a processing unit configured to perform distortion correction processing to correct distortion of the second video image, a first display unit configured to display the first video image, and a second display unit configured to display the second video image.

### BACKGROUND

### Field of the Disclosure

The present disclosure relates to a camera monitoring system for monitoring the surroundings of a moving object.

### Description of the Related Art

Electronic mirrors have been spreading by degrees as a substitution of a mirror (rear view mirror) arranged in a moving body, such as a vehicle, in recent years. Electronic mirrors each display video images of the outside of a vehicle, captured by a camera, with more and more cameras mounted in a vehicle. To reduce the cost with the increase in the number of cameras, methods are being studied in which one camera captures video images to be displayed on a plurality of monitors. For example, WO2018/207393 discusses a system of capturing video images to be displayed on an electronic rear view mirror and a rear view monitor with one camera.

Meanwhile, a vehicle may include a side view monitor for displaying a side view mounted therein to assist driving when the vehicle makes a left turn and pulls over, and in other cases. Methods are being studied in which in such a vehicle, one camera captures video images to be displayed both on an electronic side mirror and a side view monitor with a special optical system. This optical system provides a less distorted image even at a wide angle in a peripheral area.

However, a video image processing process according to a conventional method can apply correction processing to an area where the distortion correction processing is unnecessary, on a video image captured with such a special optical system. This could cause a delay in display of video images and a decrease in frame rate attributable to processing time.

### SUMMARY

Some embodiments of the present disclosure are directed to provision of a camera monitoring system with a lower processing load and a smaller number of cameras.

According to an aspect of the present disclosure, a camera monitoring system includes an imaging unit arranged in a moving object, and having a low-resolution area corresponding to an angle of view that is smaller than a predetermined angle of view and a high-resolution area corresponding to an angle of view that is larger than or equal to the predetermined angle of view and having a resolution higher than a resolution of the low-resolution area, a generating unit configured to generate a first video image including the high-resolution area based on a captured video image captured by the imaging unit and a second video image including a video image captured with the low-resolution area, a processing unit configured to perform distortion correction processing to correct distortion of the second video image generated by the generating unit, a first display unit configured to display the first video image generated by the generating unit, and a second display unit configured to display the second video image subjected to the distortion correction processing performed by the processing unit.

Further features of various embodiments will become apparent from the following description of exemplary embodiments with reference to the attached drawings.

### BRIEF DESCRIPTION OF THE DRAWINGS

FIG. 1 illustrates a camera monitoring system 100 according to a first exemplary embodiment.

FIGS. 2A and 2B illustrate an optical characteristic of an optical unit according to the first exemplary embodiment.

FIG. 3 illustrates a vehicle and an imaging range of a camera according to the first exemplary embodiment.

FIG. 4 illustrates a video image captured by an imaging unit according to the first exemplary embodiment.

FIG. 5 illustrates processing blocks of a processing unit according to the first exemplary embodiment.

FIG. 6 illustrates processing blocks of the processing unit according to a second exemplary embodiment.

FIG. 7 illustrates processing blocks of the processing unit according to a third exemplary embodiment.

FIG. 8 is a flowchart illustrating a processing procedure according to the first exemplary embodiment.

FIG. 9 is a flowchart illustrating a processing procedure according to the third exemplary embodiment.

### DESCRIPTION OF THE EMBODIMENTS

Exemplary embodiments will be described below with reference to the accompanying drawings. However, some embodiments of the present disclosure are not limited to the following exemplary embodiments. In each drawing, like numbers refer to like members or elements, and a redundant description thereof will be omitted or simplified.

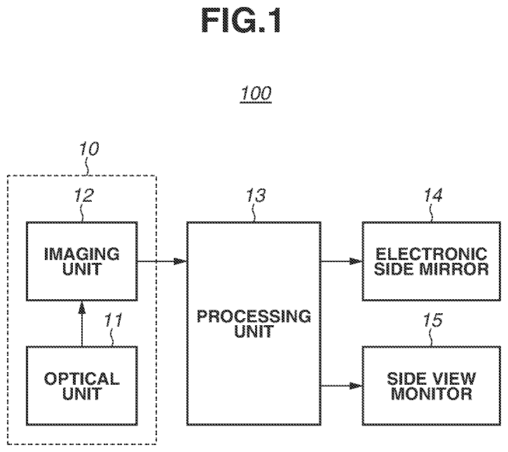

FIG. 1 illustrates a camera monitoring system 100 according to a first exemplary embodiment.

The camera monitoring system 100 is a system that displays video images captured with a camera installed at a side of a vehicle on a display apparatus in the vehicle. The camera monitoring system 100 includes a camera 10, a processing unit 13, an electronic side mirror 14, and a side view monitor 15. The processing unit 13 may be included in an information processing apparatus.

The camera 10 is an imaging device installed in the vehicle to monitor an area in the rearward of the vehicle, and includes an optical unit 11 and an imaging unit 12.

The optical unit 11 uses at least one lens for light incident from the outside to form an image on the imaging unit 12. Details of optical characteristics of the optical unit 11 will be described below.

The imaging unit 12, which is an image sensor, converts an optical object image formed by the optical unit 11 into electric signals, and transmits the electric signals to the processing unit 13.

The processing unit 13 includes a chip (SOC) circuit/field-programmable gate array (FPGA) circuit, a central processing unit (CPU) as a processor, and a memory as a storage medium. The CPU performs various kinds of control of the whole system by running computer programs stored in the memory.

In addition, the processing unit 13 develops video image signals acquired from the camera 10, and performs various kinds of image processing, such as wide dynamic range (WDR) correction, gamma correction, look-up table (LUT) processing, distortion correction, and cut-out processing. Detailed processing in the processing unit 13 will be described below.

The processing unit 13 includes various kinds of interfaces for input/output of video images, and outputs video images to the electronic side mirror 14 and the side view monitor 15.

Part or all of the functions to be carried out by the processing unit 13 may be implemented by part or all of the functions within the camera 10.

The electronic side mirror 14 is a monitor that displays an area in the side and rearward of the vehicle, and displays video images from the processing unit 13. The electronic side mirror 14 is an alternative to a side mirror in a conventional vehicle, and performs display at all times while the vehicle is moving.

The side view monitor 15 is a monitor that displays a blind angle area in the side of the vehicle, and displays video images from the processing unit 13. As the side view monitor 15, a monitor identical with the electronic side mirror 14 may be used. In this case, the side view monitor 15 performs display in a picture-in-picture (PIP) format, a picture-by-picture (PBP) format, or the like.

Subsequently, details of optical characteristics of the optical unit 11 included in the camera 10 will now be described.

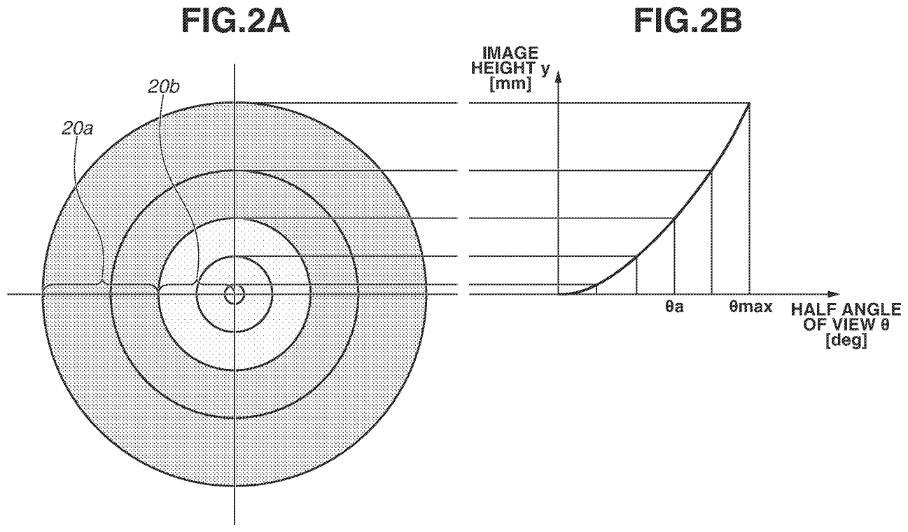

FIG. 2A illustrates an image height y in a contour-like pattern at each half angle of view on a light receiving plane of an image pickup element in the optical unit 11 according to the first exemplary embodiment. FIG. 2B illustrates a projection characteristic indicating a relationship between the image height y and a half angle of view θ in the optical unit 11 according to the first exemplary embodiment. In FIG. 2B, the abscissa axis represents the half angle of view (angle between an optical axis and incident light) θ, and the ordinate axis represents the height of an image formation (image height) y on the light receiving plane (image plane) of the camera 10.

The optical unit 11 included in the camera 10 is configured to have a projection characteristic y (θ) that changes between an area with a small half angle of view θ (near the optical axis) and an area with a large half angle of view θ (an area far from the optical axis), as illustrated as a projection characteristic in FIG. 2B. In other words, assuming that an increased amount of the image height y relative to the half angle of view θ per unit (e.g., the number of pixels per unit angle) refers to resolution, the resolution is different depending on an area.

It can also be said that this local resolution is expressed by a differential value dy(θ)/dθ of projection characteristics y(θ) at the half angle of view θ. In other words, it can also be said that the larger the gradient of the projection characteristic y(θ) illustrated in FIG. 2B is, the higher the resolution is. In addition, it can also be said that the larger an interval between image heights y at respective half angles of view in the contour like pattern illustrated in FIG. 2A is, the higher the resolution is.

In the present exemplary embodiment, an area formed on the light receiving plane of a sensor at a position closer to the center when the half angle of view θ is less than a predetermined half angle of view θa is referred to as a low-resolution area 20b, and an outward area where the half angle of view θ is the predetermined half angle of view θa or larger is referred to as a high-resolution area 20a.

In the optical system provided with such an optical characteristic, adjusting the projection characteristic y(θ) allows adjustment of a magnification ratio in the radiation direction with respect to the optical axis. This configuration allows control of an aspect ratio between the radiation direction and a circumferential direction with respect to the optical axis, which provides a less-distorted image even at a wide angle in a periphery area, unlike an image obtained by a conventional fish-eye lens or the like.

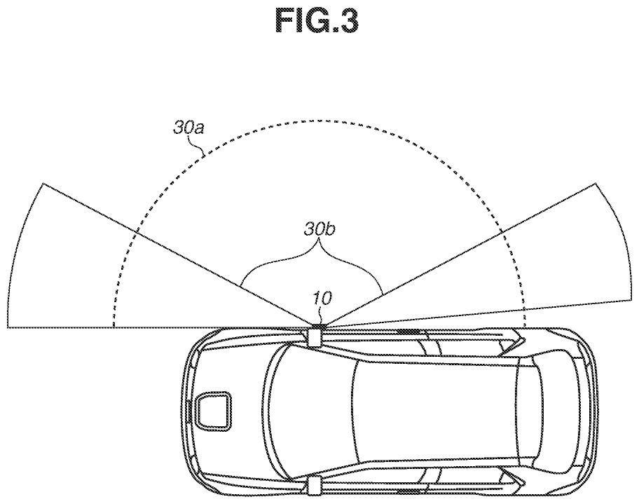

FIG. 3 illustrates the vehicle (for example, an automobile) and an imaging range of the camera 10 according to the first exemplary embodiment. The camera 10 is installed on both the right side and left side of the vehicle, but FIG. 3 illustrates the camera 10 on the right side. An imaging range 30a schematically indicates the horizontal angle of view of the camera 10. An imaging range 30b is a range in which imaging is performed with the high-resolution area 20a of the camera 10.

As illustrated in FIG. 3, the camera 10 is installed so as to face an area in the side, whereby video images to be displayed on the electronic side mirror 14 and the side view monitor 15 can be captured with one camera 10. In addition, a video image of part of the area to be displayed on the electronic side mirror 14 is captured with the high-resolution area 20a at the predetermined angle of view or larger, which provides a high-resolution, less distorted video image of the area in the side and rearward of the vehicle. To adjust the field of view of a video image to be displayed on the electronic side mirror 14, the installation direction (optical axis direction) of the camera 10 may be adjusted as appropriate.

Examples of advantages of obtaining the less distorted images of the area in the side and rearward of the vehicle include a point that lower-latency display can be performed. A large distortion in a video image being displayed makes it more difficult to determine the positional relationship between objects seen in the electronic side mirror 14, thereby creating the need for distortion correction processing to be performed on the captured video image. Conceivable methods for distortion correction include a method of performing processing using hardware, such as an FPGA circuit, and a method of performing processing with software using the CPU or the like. However, any of these methods will cause a delay. In the present exemplary embodiment, the optical characteristic of the optical unit 11 prevents the video images of the imaging area to be displayed on the electronic side mirror 14 from being distorted, which eliminates the need for distortion correction, providing a lower-latency display.

Meanwhile, the side view monitor 15 displays the area in relatively close range at a larger angle of view than the electronic side mirror 14, which could display a video image with a sense of awkwardness without distortion correction. If distortion correction is performed on the whole of such a captured video image as is the case with a conventional technique, the distortion correction is also performed on the video image of the imaging area to be displayed on the electronic side mirror 14, preventing a low latency display being provided on the electronic side mirror 14.

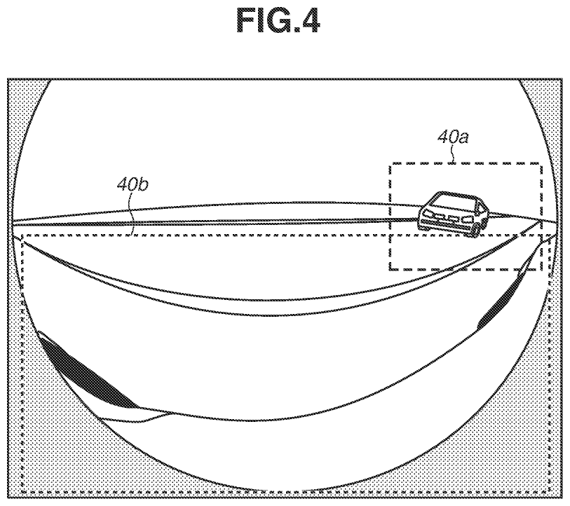

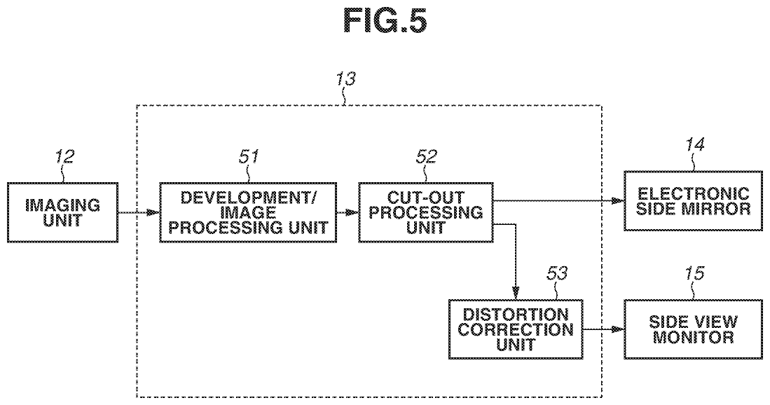

In view of the above-described issues, a description will be given of a video image processing procedure to simultaneously implement low-latency display on the electronic side mirror 14 and distortion correction on a video image to be displayed on the side view monitor 15 with reference to FIGS. 4 and 5.

FIG. 4 illustrates a video image captured by the imaging unit 12. The processing unit 13 performs processing on the video image to generate a video image to be output to the electronic side mirror 14 and a video image to be output to the side view monitor 15.

An area 40a is a video image area to be used for display on the electronic side mirror 14, and is an area seen to the side and rearward of the vehicle. An area 40b is a video image area to be used for display on the side view monitor 15, and is an area at blind angles on both sides of the vehicle. Details of the areas 40a and 40b will be described below.

FIG. 5 illustrates processing blocks in the processing unit 13.

When the processing unit 13 receives a video signal from the imaging unit 12, a development/image processing unit 51 first processes the signal. In addition to development processing, various kinds of correction processing, such as WDR correction and gamma correction, are performed here.

A cut-out processing unit 52 cuts out the areas 40a and 40b from the processed video image.

The area 40a is an area that is being captured in the side and rearward of the vehicle and is to be displayed on the electronic side mirror 14. The video image output on the electronic side mirror 14 without distortion processing does not have an awkward feel thanks to the optical characteristic of the optical unit 11. A cut-out area is preferably an area cut out from the high-resolution area 20a, but is not limited thereto. For example, the low-resolution area 20b, part of which is at a lower angle of view than a predetermined angle of view, may be included. In this case, the area 40a is preferably cut out so that the center of the area 40a is included in the high-resolution area 20a. Since the area 40a is an imaging area whose video image is to be displayed on the electronic side mirror 14, it is preferable that the area 40a be cut out from a video image of an area in the rearward of the vehicle in the traveling direction. In other words, for example, with the camera 10 installed on the right side, the area 40a is preferably cut out so that the center of the area 40a is located on the right side of the center of the imaging area seen in FIG. 4.

The electronic side mirror 14 is a monitor that mimics a mirror, and processing in either the processing unit 13 or the electronic side mirror 14 includes processing of reversing the left and the right.

While a video signal from the area 40a is transmitted by the cut-out processing unit 52 to the electronic side mirror 14 via a video signal interface (not illustrated), a correction unit (not illustrated) that performs distortion correction or other processing may be arranged between the cut-out processing unit 52 and the electronic side mirror 14. In this case, with less distortion by optical characteristics of the optical unit 11, smaller-scale (low-latency) processing than by a distortion correction unit 53, which will be described below, is sufficient.

The area 40b is an area to be used for a video image to be output to the side view monitor 15 by the distortion correction unit 53. A cut-out range (area) that is cut out by the cut-out processing unit 52 is set as appropriate depending on the range to be displayed on the side view monitor 15. For example, if the side view monitor 15 is used when the vehicle pulls over, the cut-out processing unit 52 cuts out an area at blind angles in the vicinity of its front and rear tires. If visual recognition of the vicinity of its front and rear tires at blind angles is effective for preventing an entanglement accident when the vehicle makes a right or left turn, or when the vehicle passes by another vehicle, the cut-out processing unit 52 cuts out such an area that includes the vicinity of the front and rear tires of the vehicle. More specifically, the cut-out processing unit 52 preferably cuts out the area 40b so that the center of the area 40b is located on the lower side of the center of the imaging area in the appearance illustrated in FIG. 4. A cut-out area to be cut out by the cut-out processing unit 52 is set as appropriate depending on an area in the physical space corresponding to a video image to be displayed on the side view monitor 15. Settings of the range to be displayed on the side view monitor 15 or the area in the physical space may be made by a user.

The cut-out area 40b goes through distortion correction processing by the distortion correction unit 53. The cut-out processing unit 52 may perform cut-out processing as appropriate for the side view monitor 15 as an output destination. Thereafter, the video signal is transmitted by the distortion correction unit 53 to the side view monitor 15 via the video image interface (not illustrated).

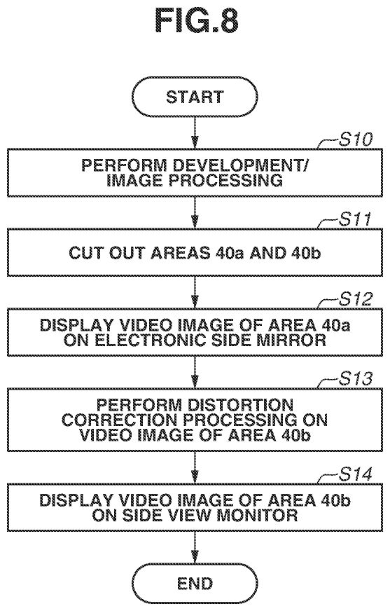

FIG. 8 illustrates a processing procedure according to the present exemplary embodiment. In step S10, the processing unit 13 performs development processing and image processing as appropriate on the video signal received from the imaging unit 12. In step S11, the processing unit 13 performs cut-out processing to cut out areas corresponding to the above-mentioned areas 40a and 40b. In step S12, the processing unit 13 displays a video image of the cut-out area 40a on the electronic side mirror 14. In step S13, the processing unit 13 performs distortion correction processing on a video image of the cut-out area 40b. In step S14, the processing unit 13 displays the video image of the area 40b through the distortion correction processing on the side view monitor 15.

The above-mentioned video image processing procedure prevents a delay caused by the distortion correction processing in the display of the electronic side mirror 14, thereby providing a low-latency display. A video image on the side view monitor 15 through the distortion correction processing is displayed without a sense of awkwardness due to distortion. The display on the side view monitor 15 remains delayed by the distortion correction processing. However, since the side view monitor 15 is assumed to be used when the vehicle is moving at a low speed, such as when the vehicle pulls over and passes by another car, there is relatively little demand for addressing a delay, and the influence is limited in comparison with a delay in the display on the electronic side mirror 14. In other words, the above-mentioned video image processing procedure allows a display delay caused by the distortion correction processing to be limited to the display on the side view monitor 15, which is less susceptible to the influence of the delay.

A second exemplary embodiment will now be described. In the first exemplary embodiment, the processing in the distortion correction unit 53 can be implemented as, in addition to processing performed by hardware, such as the FPGA circuit and an application-specific integrated circuit (ASIC), processing performed by software using the CPU or the like. The processing performed by software is advantageous in enabling reduction of hardware resources, in addition to ease of implementation. Meanwhile, pipeline processing like processing performed by hardware is difficult. The processing performed by software is disadvantageous in that a frame rate of a video image depends on the time taken to perform correction processing.

In the second exemplary embodiment, a description will be given of an example of preventing a decrease in frame rate of display on the electronic side mirror 14 with distortion correction processing for display on the side view monitor 15 being performed by software.

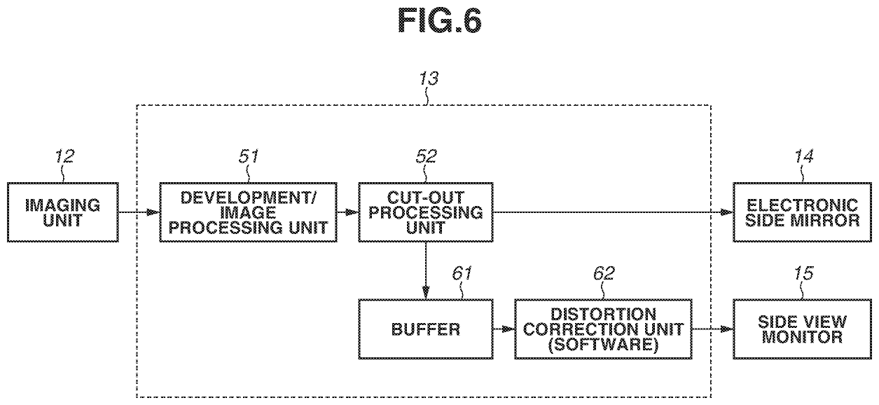

FIG. 6 is a processing block diagram in the second exemplary embodiment.

A video signal from the area 40b cut out by the cut-out processing unit 52 is held in a buffer 61 on a frame-by-frame basis.

A distortion correction unit 62 is a block that performs distortion correction with software. After completion of correction processing in a frame, the distortion correction unit 62 receives the frame held in the buffer 61 and performs successive correction processing. The cut-out processing unit 52 may perform cut-out processing as appropriate for the electronic side mirror 14 as an output destination. Thereafter, the video signal is transmitted to the electronic side mirror 14 via a video image interface (not illustrated).

Similarly to the first exemplary embodiment, a video signal from the area 40a is directly transmitted to the electronic side mirror 14 via a video signal interface (not illustrated). Thus, the frame rate of the video image to be output to the electronic side mirror 14 is not decreased by the distortion correction processing.

Similarly to the first exemplary embodiment, a correction unit (not illustrated) that performs distortion correction or other processing may be arranged between the cut-out processing unit 52 and the electronic side mirror 14. The correction unit may perform processing with hardware. In this case, the frame rate of a video image to be output to the electronic side mirror 14 is not decreased by the pipeline processing.

The other configurations and processing procedure are similar to those of the first exemplary embodiment.

The above-mentioned video image processing allows output of a video image to the electronic side mirror 14 without being affected by a decrease in frame rate, while displaying a video image through distortion correction by software on the side view monitor 15.

A third exemplary embodiment will be described. A form of an electronic side mirror, among other electronic side mirrors alternative to side mirrors, that dynamically changes a display area making use of the characteristics as an electronic monitor is known. For example, there are techniques of controlling a display area through a driver's operation of a button, or automatically expanding the display range of the electronic side mirror on the traveling direction side to prevent an entanglement accident when the vehicle makes a right or left turn.

Meanwhile, when the above-mentioned technique is applied to video images captured with a camera having optical characteristics like those of the optical unit 11 according to the present disclosure, the visibility of the video images displayed on the electronic side mirror can deteriorate depending on the display range. Specifically, when the area 40a described in the first exemplary embodiment is expanded to expand the area to be displayed on the electronic side mirror, the visibility of the side and rear area can deteriorate due to conspicuous distortion that appears depending on the range. In this case, it is conceivable that it is desirable to prioritize improvement of visibility by distortion correction processing over a display rate.

In view of such situations, a form will be described that enables switching of whether or not distortion correction is performed on a video image to be displayed on the electronic side mirror 14 depending on the area to be displayed on the electronic side mirror 14 in the present exemplary embodiment.

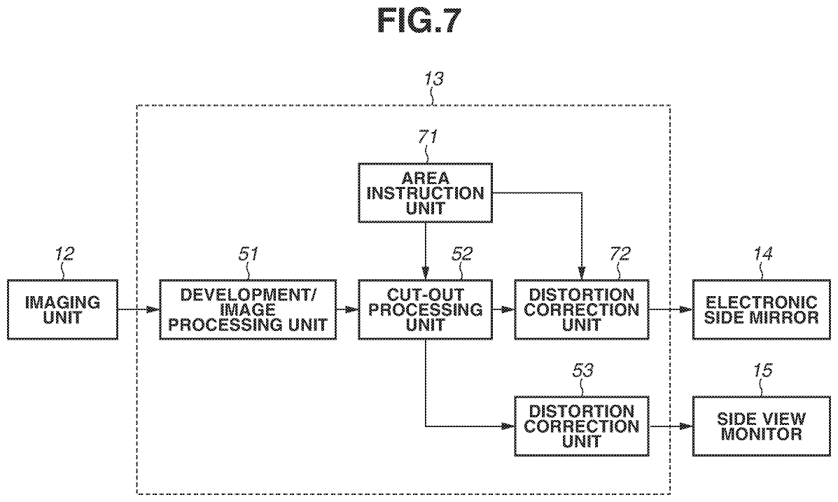

FIG. 7 is a processing block diagram according to the third exemplary embodiment.

An area instruction unit 71 determines a cut-out area in an imaging range 30a and makes the instruction to the cut-out processing unit 52. Specifically, for example, the area instruction unit 71 detects the driver's operation on a button or a steering state, such as when the vehicle makes a right or left turn, selects an appropriate value accordingly out of coordinate information about the imaging range 30a preliminarily stored in the memory, and instructs the cut-out processing unit 52 about the appropriate value as a cut-out area for the area 40a.

In addition, the area instruction unit 71 instructs a distortion correction unit 72 about whether or not to perform distortion correction processing depending on the range of the area 40a that is instructed to the cut-out processing unit 52. For example, if the angle of view of the area 40a in the horizontal or vertical direction exceeds a predetermined threshold, the area instruction unit 71 instructs the distortion correction unit 72 to perform correction processing. Otherwise, the area instruction unit 71 instructs the distortion correction unit 72 not to perform the correction processing. Alternatively, if the area 40a includes the angle of view that exceeds a predetermined threshold in the horizontal or vertical direction of the imaging range 30a, the area instruction unit 71 instructs the distortion correction unit 72 to perform the correction processing. Otherwise, the area instruction unit 71 instructs the distortion correction unit 72 not to perform the correction processing.

The distortion correction unit 72 performs the distortion correction processing on a video image of the area 40a only when instructed by the area instruction unit 71 to perform the correction processing. Otherwise, the distortion correction unit 72 outputs an input video image of the area 40a as it is. The other configurations are similar to those of the first exemplary embodiment.

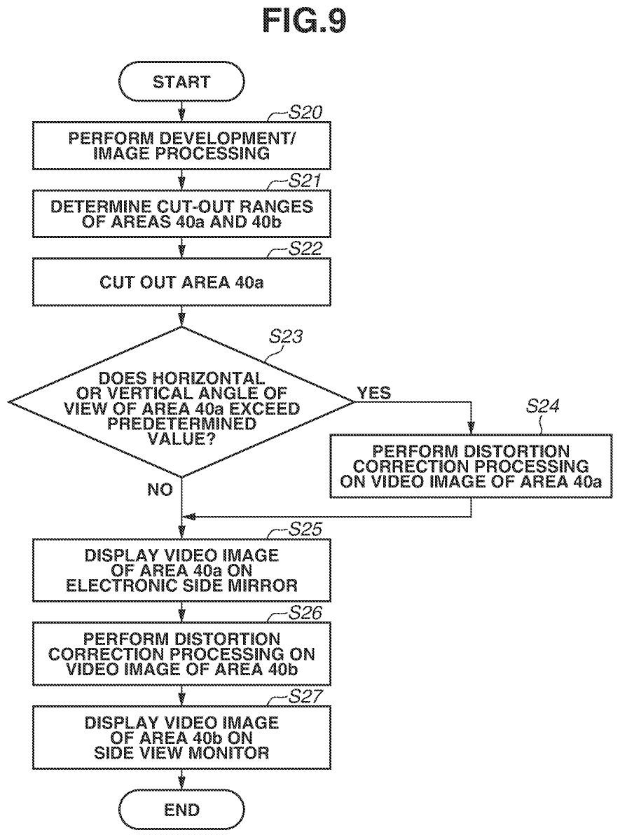

FIG. 9 illustrates a processing procedure according to the present exemplary embodiment. In step S20, the processing unit 13 performs development processing and image processing as appropriate on the video signal received from the imaging unit 12. In step S21, the area instruction unit 71 determines areas corresponding to the above-mentioned areas 40a and 40b. In step S22, the processing unit 13 performs cut-out processing to cut out an area corresponding to the area 40a.

In step S23, the processing unit 13 determines whether the angle of view of the area 40a in the horizontal or vertical direction exceeds a predetermined value. If the angle of view exceeds the predetermined value (YES in step S23), the processing proceeds to step S24. In step S24, the processing unit 13 performs distortion correction processing on a video image of the area 40a. In step S25, the processing unit 13 displays the video image of the area 40a on the electronic side mirror 14. In step S26, the processing unit 13 performs distortion correction processing on the video image of the cut-out area 40b. Finally, in step S27, the processing unit 13 displays the video image of the area 40b through the distortion correction processing on the side view monitor 15.

The video image processing procedure allows display of video images without a sense of awkwardness due to distortion even with an expanded display range of the electronic side mirror 14.

While the detailed description has been given of exemplary embodiments of the present disclosure, some embodiments of the present disclosure are not limited to the above-mentioned exemplary embodiments, and various modifications can be made based on the gist of the present disclosure and are not excluded from the scope of the present disclosure.

Some embodiments of the present disclosure are implemented by execution of the following processing, as well as by an information processing apparatus.

Software (a program) that implements functions of the above-mentioned exemplary embodiments is installed in a system or an apparatus via a network for data communication or a storage medium of various kinds. The processing is implemented by the system or a computer (or a CPU or a microprocessing unit (MPU)) of the apparatus loading and running the program. Alternatively, the program may be stored in a computer-readable storage medium and installed.

According to the present disclosure, a compact camera monitoring system can be provided with a smaller number of cameras and lower processing load.

### OTHER EMBODIMENTS

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2022-106165, which was filed on Jun. 30, 2022 and which is hereby incorporated by reference herein in its entirety.

What is claimed is:

1. A camera monitoring system comprising:
an imaging unit arranged in a moving object, and having a low-resolution area corresponding to an angle of view that is smaller than a predetermined angle of view and a high-resolution area corresponding to an angle of view that is larger than or equal to the predetermined angle of view and having a resolution higher than a resolution of the low-resolution area;
one or more memories;
one or more processors, wherein the one or more processors and the one or more memories are configured to:
generate a first video image including the high-resolution area based on a captured video image captured by the imaging unit,
generate a second video image including a video image captured with the low-resolution area, and
perform distortion correction processing to correct distortion of the second video image;
a first display unit configured to display the first video image; and
a second display unit configured to display the second video image subjected to the distortion correction processing.

2. The camera monitoring system according to claim 1, wherein the one or more processors and the one or more memories are further configured to make a frame rate at which the first video image is output to the first display unit higher than a frame rate at which the second video image is output to the second display unit.

3. The camera monitoring system according to claim 1, wherein the one or more processors and the one or more memories are further configured to cut out the first video image so that a center of the first video image is located in a rear of a center of the captured video image in a traveling direction of the moving object.

4. The camera monitoring system according to claim 3, wherein the one or more processors and the one or more memories are further configured to cut out the second video image so that a center of the second video image is located lower the center of the captured video image.

5. The camera monitoring system according to claim 1, wherein the one or more processors and the one or more memories are further configured to:
determine a cut-out range of the second video image cut out from the captured video image captured by the imaging unit, and
determine whether to perform the distortion correction processing depending on the cut-out range of the second video image.

6. The camera monitoring system according to claim 5, wherein, with an angle of view of an area in the first video image in the captured video image captured by the imaging unit exceeding a predetermined threshold, the one or more processors and the one or more memories are further configured to perform the distortion correction processing on the generated second video image.

7. The camera monitoring system according to claim 5, wherein the one or more processors and the one or more memories are further configured to determine the cut-out range of the second video image depending on a steering state of the moving object.

8. The camera monitoring system according to claim 5, wherein the one or more processors and the one or more memories are further configured to set the cut-out range of the second video image based on an area in a physical space, the area corresponding to the second video image and being set by a user.

9. A camera monitoring system, comprising:
an imaging unit arranged in a moving object, and having a low-resolution area corresponding to an angle of view that is smaller than a predetermined angle of view and a high-resolution area corresponding to an angle of view that is larger than or equal to the predetermined angle of view and having a resolution higher than a resolution of the low-resolution area;
one or more memories;
one or more processors, wherein the one or more processors and the one or more memories are configured to:
generate a first video image including the high-resolution area based on a captured video image captured by the imaging unit,
generate a second video image including a video image captured with the low-resolution area, and
perform distortion correction processing to correct distortion of the generated second video image;
a first display unit configured to display the first video image; and
a second display unit configured to display the second video image subjected to the distortion correction processing.

10. A control method for a camera monitoring system, the method comprising:
performing imaging by an imaging unit arranged in a moving object, the imaging unit having a low-resolution area corresponding to an angle of view that is smaller than a predetermined angle of view and a high-resolution area corresponding to an angle of view that is larger than or equal to the predetermined angle of view and having a resolution higher than a resolution of the low-resolution area;
generating a first video image including the high-resolution area based on a captured video image captured by the imaging unit and a second video image including a video image captured with the low-resolution area;
performing distortion correction processing to correct distortion of the generated second video image;
performing first display to display the generated first video image; and
performing second display to display the second video image subjected to the distortion correction processing.

11. A computer-readable storage medium storing computer-executable instructions that, when executed by one or more computers, cause the one or more computers to perform operations comprising:
performing imaging by an imaging unit arranged in a moving object, the imaging unit having a low-resolution area corresponding to an angle of view that is smaller than a predetermined angle of view and a high-resolution area corresponding to an angle of view that is larger than or equal to the predetermined angle of view and having a resolution higher than a resolution of the low-resolution area;
generating a first video image including the high-resolution area based on a captured video image captured by the imaging unit and a second video image including a video image captured with the low-resolution area;
performing distortion correction processing to correct distortion of the generated second video image;
performing first display to display the generated first video image; and
performing second display to display the second video image subjected to the distortion correction processing.

12. An information processing apparatus comprising:
one or more memories;
one or more processors, wherein the one or more processors and the one or more memories are configured to:
generate, based on a captured video image captured by an imaging unit arranged in a moving object, the imaging unit having a low-resolution area corresponding to an angle of view that is smaller than a predetermined angle of view and a high-resolution area corresponding to an angle of view that is larger than or equal to the predetermined angle of view and having a resolution higher than a resolution of the low-resolution area, a first video image including the high-resolution area, and a second video image including a video image captured with the low-resolution area;
perform distortion correction processing to correct distortion of the second video image;
cause a first display unit to display the first video image; and
cause a second display unit to display the second video image subjected to the distortion correction processing.
